(19) United States
(12) Patent Application Publication
(10) Pub. No.: US 2025/0040597 A1
(43) Pub. Date: Feb. 6, 2025

(54) ELECTRONIC ATOMIZER WITH TOBACCO PIPE SHAPE

(71) Applicant: Shenzhen Impetus Technology Co., Ltd., Shenzhen (CN)

(72) Inventors: Liqian Chen, Shenzhen (CN); Ming Zhang, Shenzhen (CN)

(21) Appl. No.: 18/364,722

(22) Filed: Aug. 3, 2023

(51) Int. Cl. A24F 40/40; A24F 40/60; A24F 40/90

(52) U.S. Cl. CPC A24F 40/40; A24F 40/60; A24F 40/90; H02J 50/10

(57) ABSTRACT

The invention provides an electronic atomizer with tobacco pipe shape, comprising a housing provided with an assembly cavity; the housing is provided with a mounting part, which is arranged with a mounting cavity to be communicated with assembly cavity; the housing is also provided with an air inlet communicated with mounting cavity; a host structure is disposed within assembly cavity; a connecting structure is arranged in mounting cavity and is electrically connected with host structure; an atomizing core can generate smoke and is detachably connected with the connecting structure, when connected, the atomizing core is electrically connected with the connecting structure; and a cigarette holder is provided with an accommodating cavity and a smoke outlet; the cigarette holder is detachably connected with the mounting part or connecting structure, when connected, the atomizing core is positioned in the accommodating cavity. The electronic atomizer allows for mounting and replacing atomizing core.

### 1. TECHNICAL FIELD

The invention belongs to the technical field of atomization device, and particularly relates to an electronic atomizer with tobacco pipe shape.

### 2. BACKGROUND ART

The electronic atomizer is an electronic product that imitates cigarette, with the same appearance, smoke, taste and feel of cigarettes. It's a product that converts nicotine to vapor for its user to suck via atomization. Electronic atomizers in the market are generally in cylindrical shape; despite of the fact that electronic atomizers with tobacco pipe shape have appeared with increasing social demand, the atomizing core, i.e. cartridge in current electronic atomizers with tobacco pipe shape can not be changed and can not meet users' demand for changing cartridges.

### 3. SUMMARY OF THE INVENTION

The invention provides an electronic atomizer with tobacco pipe shape to solve the technical problems mentioned in above background art.

The technical scheme provided by the invention is an electronic atomizer with tobacco pipe shape, comprising

a housing, which is provided with an assembly cavity; a mounting part is provided on the outer peripheral surface of said housing in circumferential direction; said mounting part is arranged with a mounting cavity; said mounting cavity is communicated with the assembly cavity, and the housing is also provided with an air inlet communicated with the mounting cavity;

a host structure is disposed within the assembly cavity;

a connecting structure is arranged in the mounting cavity and is electrically connected with the host structure;

an atomizing core can generate smoke and is detachably connected with the connecting structure, and when the atomizing core is connected with the connecting structure, the atomizing core is electrically connected with the connecting structure;

and a cigarette holder is provided with an accommodating cavity and a smoke outlet communicated with the accommodating cavity; the cigarette holder is detachably connected with the mounting part or the connecting structure, and when the cigarette holder is connected with the mounting part or the connecting structure, the atomizing core is positioned in the accommodating cavity.

As a preferred solution of the invention, said mounting part and housing are integrally formed.

As a preferred solution of the invention, said mounting part is formed by extending the outer peripheral surface of the housing outwards so that the mounting part protrudes out of the housing.

As a preferred solution of the invention, said atomizing core is in threaded connection with said connecting structure.

As a preferred solution of the invention, said connecting structure is connected with the mounting part through the buckle structure.

As a preferred solution of the invention, the inner wall of the mounting part is provided with the first clamping part, on said connecting structure is provided with the second clamping part, and the first clamping part and the second clamping part are clamped with each other.

As a preferred solution of the invention, the connecting structure includes a connection seat, a thread seat, an insulating member, and an electrode, the connection seat is connected to the mounting part, the thread seat is connected to the connection seat, the electrode is disposed in the thread seat, and the electrode and the thread seat are separated by the insulating member, so that the thread seat and the electrode form positive and negative poles; and said thread seat and the electrode are respectively electrically connected with the host structure, the atomizing core is in threaded connection with the thread seat, and when the atomizing core is connected with the thread seat, the atomizing core is simultaneously in contact with the electrode.

As a preferred solution of the invention, the host structure includes a PCB board and a key, the PCB board is disposed in the assembly cavity, and the key is disposed on the end surface of the housing along the axial direction and electrically connected to the PCB board.

As a preferred solution of the invention, the host structure also includes the wireless charging coil, which is arranged on one end of the mounting cavity that is far away from the key, and is electrically connected to the PCB board.

As a preferred solution of the invention, it also includes a wireless charging base, which is used to support one end of the housing that is far away from the key so as to make the wireless charging coil able to sense said wireless charging base.

### 4. BRIEF DESCRIPTION OF ACCOMPANY DRAWINGS

In order to illustrate the preferred embodiment of the invention or the technical scheme more clearly, the invention is further described in detail hereinafter with reference to the drawings. Obviously, only partial embodiments of the invention are shown and the actual structure is not limited thereto. It is to be understood by those skilled in the art that other drawings can be obtained based on the drawings of the invention with non-creative labor.

FIG. 1 is the structural diagram of the electronic atomizer with tobacco pipe shape provided by the invention;

FIG. 2 is the top view of the electronic atomizer with tobacco pipe shape provided by the invention;

FIG. 3 is the sectional view of position A-A in FIG. 2.

FIG. 4 is the breakdown drawing of the electronic atomizer with tobacco pipe shape provided by the invention;

As shown in the drawing:

100. housing, 110. assembly cavity, 120. mounting part, 130. mounting cavity, 140. air inlet, 200. host structure, 210. PCB board, 220. key, 230. wireless charging coil, 300. connecting structure, 310. connection seat, 320. thread seat, 330. insulating member, 340. electrode, 400. atomizing core, 500. cigarette holder, 510. accommodating cavity, 520. smoke outlet, 600. buckle structure, 700. wireless charging base.

### 5. SPECIFIC EMBODIMENT OF THE INVENTION

In order to make the problems to be solved, technical solutions and advantages of the embodiments of the present invention clearer, the technical solutions in the embodiments of the invention will be clearly and completely described below with reference to the drawings in the embodiments, and it should be noted that the following detailed description of the embodiments of the invention is not intended to limit the scope of the invention, but is merely to describe the invention.

It should be noted that when one element is described as “fixed to” or “arranged on” the other element, it can be directly or indirectly on the other element, and when one element is described as “connected with” the other element, it can be directly or indirectly connected with the other element.

It should be understood that, if the terms “length”, “width”, “upper”, “lower”, “front”, “back”, “left”, “right”, “vertical”, “horizontal”, “top”, “bottom”, “inside”, “outside” indicate orientations or positional relationships based on the orientations or positional relationships shown in the drawings, the orientations or positional relationships are only used for convenience of describing the invention and simplifying the description, but the terms do not indicate or imply that the devices or elements indicated must have specific orientations, be constructed in specific orientations, and operate, and therefore, should not be construed as limiting the invention.

Furthermore, the terms “first” and “second” are used for descriptive purposes only and are not to be understood as indicating or implying relative importance or implicitly specifying the number of technical features indicated. Thus, a feature defined with the terms “first” and “second” may expressly or implicitly include one or more such features. In the description of the invention, “a plurality of” means two or more, unless otherwise expressly and specifically limited.

The electronic atomizer is an electronic product that imitates cigarette, with the same appearance, smoke, taste and feel of cigarettes. It's a product that converts nicotine to vapor for its user to suck via atomization.

With increasing social demand, users have more requirements for the appearance of electronic atomizer. For example, electronic atomizers intimating tobacco pipe shape have be generated at present, but the atomizing core, i.e. cartridge in current electronic atomizers of such type can not be changed and only E-liquid can be infused into the atomizing core. However, many users have been accustomed to changing the atomizing core, that is replacing with a new atomizing core after all the E-liquid in the atomizing core being atomized, therefore, electronic atomizers with tobacco pipe shape can not meet users' demand well.

In order to solve the problem of unable to change the atomizing core in existing electronic atomizers, the invention provides an electronic atomizer with tobacco pipe shape, which can facilitate changing the atomizing core.

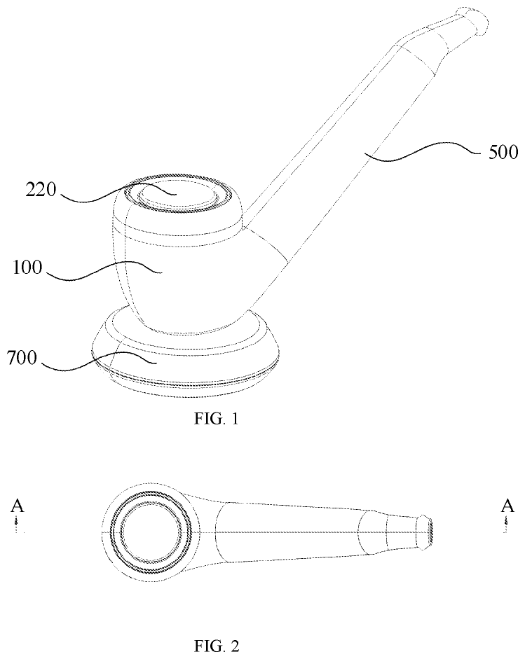

With reference to FIG. 1 to FIG. 4, the electronic atomizer with tobacco pipe shape comprises a housing 100, a host structure 200, a connecting structure 300, an atomizing core 400, and a cigarette holder 500.

Wherein the housing is provided with an assembly cavity 110; a mounting part 120 is provided on the outer peripheral surface of said housing 100 in circumferential direction; said mounting part 120 is arranged with a mounting cavity 130; said mounting cavity 130 is communicated with the assembly cavity 110.

It can be understood that said mounting part 120 is not arranged in the axial direction of the housing 100, so as to make the electronic atomizer form the shape of tobacco pipe.

The host structure 200 is disposed within the assembly cavity 110. It can be understood that the host structure functions as the control center to control whether the electronic atomizer is able to work.

The connecting structure 300 is arranged in the mounting cavity 130 and is electrically connected with the host structure 200; wherein the connecting structure 300 arranged in the mounting cavity 130 refers to that at least partial of the connecting structure 300 is arranged in the mounting cavity 130, which means that it can either be partial of the connecting structure 300 arranged in the mounting cavity 130, or the whole structure arranged in the mounting cavity 300. The connecting structure 300 is electrically connected with the host structure 200 via the power cord.

The atomizing core 400 refers to a device that can generate smoke, that is, when the atomizing core 400 works, the atomizing core 400 can generate smoke. The specific structure of the atomizing core 400 can adopts conventional method, so no more detailed description will be given herein.

Specifically, atomizing core 400 is detachably connected with the connecting structure 300; for instance, the atomizing core 400 is in threaded connection with said connecting structure 300 to facilitate mounting and replacing of the atomizing core 400.

When the atomizing core 400 is connected with the connecting structure 300, the atomizing core 400 is electrically connected with the connecting structure 300, for instance, the atomizing core 400 and the connecting structure 300 contact with each other.

It can be understood that since the connecting structure 300 is electrically connected with the host structure 200, when the atomizing core 400 is electrically connected with the connecting structure 300, the host structure 200 can control the atomizing core 400 to work.

The cigarette holder 500 is provided with an accommodating cavity 510 and a smoke outlet 520 communicated with the accommodating cavity 510; the accommodating cavity 510 is used to accommodate the atomizing core 400 and the smoke outlet 520 is used for smoke discharge and being sucked by user. Wherein the cigarette holder 500 can be made of plastic, silicone or glass and other materials.

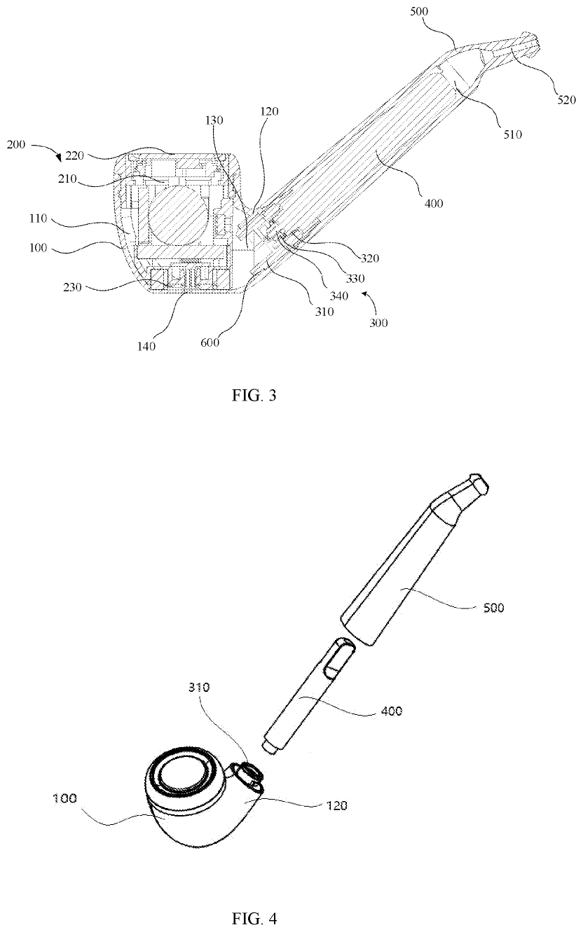

With reference to FIG. 3 and FIG. 4, in some embodiments, the cigarette holder 500 is detachably connected with the connecting structure 300; for instance, the cigarette holder 500 can be sleeved to the connecting structure 300, or be connected to the connecting structure 300 via threaded connection.

In other embodiments, the cigarette holder 500 is detachably connected with the mounting part 120.

Furthermore, when the cigarette holder 500 is connected with the mounting part 120 or the connecting structure 300, the atomizing core 400 is positioned in the accommodating cavity 510, which can hide the atomizing core 400 in the cigarette holder 500 with strong concealment; meanwhile the cigarette holder 500 can protect the atomizing core 400 and prevent the atomizing core 400 from being broken.

When the host structure 200 controls the atomizing core 400 to work, the smoke generated from the atomizing core 400 be sucked by its user via the smoke outlet 520.

It can be understood that when the user smokes, in order to make air flows, the electronic atomizer also includes an air inlet 140 so as to let the outside air can get into the electronic atomizer via the air inlet 140. For example, air inlet can be arranged in the housing 100 and the specific position thereof can be arranged according to actual needs; the air inlet 140 is communicated with the mounting cavity 130 so that the the outside air can get into the atomizing core 400 and take away smoke.

It can be seen in the electronic atomizer of the application that the mounting part 120 is provided on the outer peripheral surface of said housing 100 in circumferential direction and the connecting structure 300 is arranged on the mounting part 120, so when the cigarette holder 500 is mounted on the connecting structure 300 or the mounting part 120, the the whole electronic atomizer can present the shape of cigarette pipe. In the electronic atomizer with cigarette pipe shape, the connecting structure 300 can be used to detachably mount the atomizing core 400 and the cigarette holder 500 is provided with an accommodating cavity 510 to accommodate the atomizing core 400 so that the atomizing core 400 can be mounted properly on the cigarette holder 500 to facilitate mounting and replacing of the atomizing core 400, and the atomizing core 400 can be hidden by the cigarette holder 500 to protect the atomizing core 400.

With reference to FIG. 3, in some embodiments, said mounting part 120 and housing 100 are integrally formed. Of course in other embodiments, the mounting part 120 and housing 100 can be arranged separately.

Furthermore, said mounting part 120 is formed by extending the outer peripheral surface of the housing 100 outwards so that the mounting part 120 protrudes out of the housing 100 and there is enough space in the mounting part 120 to mount the connecting structure 300.

With reference to FIG. 3, in order to facilitate assembling the connecting structure 300 and mounting part 120, said connecting structure 300 is connected with the mounting part 120 through the buckle structure 600.

For instance, the inner wall of the mounting part 120 (i.e. the side wall of the mounting cavity 130) is provided with the first clamping part, on said connecting structure 300 is provided with the second clamping part, and the first clamping part and the second clamping part are clamped with each other to realize connection between the connecting structure 300 and mounting part 120.

With reference to FIG. 3, in order to facilitate the host structure 200 and the atomizing core 400 are electrically connected with the connecting structure 300 respectively, the connecting structure 300 can also includes a connection seat 310, a thread seat 320, an insulating member 330, and an electrode 340, wherein the connection seat 310 is connected to the mounting part 120, the thread seat 320 is connected to the connection seat 310, the electrode 340 is disposed in the thread seat 320, and the electrode 340 and the thread seat 320 are separated by the insulating member 330, so that the thread seat 320 and the electrode 340 form positive and negative poles; said thread seat 320 and the electrode 340 are respectively electrically connected with the host structure 200, the atomizing core 400 is in threaded connection with the thread seat 320, and when the atomizing core 400 is connected with the thread seat 320, the atomizing core 400 is simultaneously in contact with the electrode 340.

It means that the host structure 200 can be electrically connected with the atomizing core 400 through the positive and negative poles formed by the thread seat 320 and the electrode 340.

With reference to FIG. 3, in some embodiments, the host structure 200 includes a PCB board 210 and a key 220, the PCB board 210 is disposed in the assembly cavity 110, and the key 220 is disposed on the end surface of the housing 100 along the axial direction and electrically connected to the PCB board 210. The use can control the atomizing core 400 to work or not by controlling the key 220.

In addition, the host structure 200 also includes the wireless charging coil 230 to realize wireless charging of the electronic atomizer. The wireless charging coil 230 is arranged on one end of the mounting cavity 110 that is far away from the key 220, and is electrically connected to the PCB board 210.

In some embodiments, with reference to FIG. 1, the electronic atomizer can also be equipped with a wireless charging base 700, which is used to support one end of the housing 100 that is far away from the key 220 so as to make the wireless charging coil 230 able to sense said wireless charging base 700, further enabling the wireless charging base 700 realize wireless charging of the electronic atomizer through wireless charging coil 230.

The invention and its embodiments have been described above, but the description is not limited thereto; only one embodiment of the invention is shown in the drawings, and the actual structure is not limited thereto. Any modification, equivalent replacement, and improvement made within the spirit and principle of the invention shall all fall within the protective scope of the invention.

1. An electronic atomizer with tobacco pipe shape, comprising
a housing, which is provided with an assembly cavity; a mounting part is provided on the outer peripheral surface of said housing in circumferential direction; said mounting part is arranged with a mounting cavity; said mounting cavity is communicated with the assembly cavity, and the housing is also provided with an air inlet communicated with the mounting cavity;
a host structure is disposed within the assembly cavity;
a connecting structure is arranged in the mounting cavity and is electrically connected with the host structure;
an atomizing core can generate smoke and is detachably connected with the connecting structure, and when the atomizing core is connected with the connecting structure, the atomizing core is electrically connected with the connecting structure;
and a cigarette holder is provided with an accommodating cavity and a smoke outlet communicated with the accommodating cavity; the cigarette holder is detachably connected with the mounting part or the connecting structure, and when the cigarette holder is connected with the mounting part or the connecting structure, the atomizing core is positioned in the accommodating cavity.

2. The electronic atomizer with tobacco pipe shape of claim 1 wherein said mounting part and housing are integrally formed.

3. The electronic atomizer with tobacco pipe shape of claim 2 wherein said mounting part is formed by extending the outer peripheral surface of the housing outwards so that the mounting part protrudes out of the housing.

4. The electronic atomizer with tobacco pipe shape of claim 1 wherein said atomizing core is in threaded connection with said connecting structure.

5. The electronic atomizer with tobacco pipe shape of claim 1 wherein said connecting structure is connected with the mounting part through the buckle structure.

6. The electronic atomizer with tobacco pipe shape of claim 5 wherein the inner wall of the mounting part is provided with the first clamping part, on said connecting structure is provided with the second clamping part, and the first clamping part and the second clamping part are clamped with each other.

7. The electronic atomizer with tobacco pipe shape of claim 5 wherein the connecting structure includes a connection seat, a thread seat, an insulating member, and an electrode, the connection seat is connected to the mounting part, the thread seat is connected to the connection seat, the electrode is disposed in the thread seat, and the electrode and the thread seat are separated by the insulating member, so that the thread seat and the electrode form positive and negative poles; and
said thread seat and the electrode are respectively electrically connected with the host structure, the atomizing core is in threaded connection with the thread seat, and when the atomizing core is connected with the thread seat, the atomizing core is simultaneously in contact with the electrode.

8. The electronic atomizer with tobacco pipe shape of claim 1 wherein the host structure includes a PCB board and a key, the PCB board is disposed in the assembly cavity, and the key is disposed on the end surface of the housing along the axial direction and electrically connected to the PCB board.

9. The electronic atomizer with tobacco pipe shape of claim 1 wherein the host structure also includes the wireless charging coil, which is arranged on one end of the mounting cavity that is far away from the key, and is electrically connected to the PCB board.

10. The electronic atomizer with tobacco pipe shape of claim 8 wherein it also includes a wireless charging base, which is used to support one end of the housing that is far away from the key so as to make the wireless charging coil able to sense said wireless charging base.
